(19) United States
(12) Patent Application Publication
(10) Pub. No.: US 2020/0037816 A1
(43) Pub. Date: Feb. 6, 2020

(54) VERSATILE PIZZA OVEN

(71) Applicant: BBQ GUY'S MANUFACTURING, LLC, Baton Rouge, LA (US)

(72) Inventor: Michael F. Hackley, Baton Rouge, LA (US)

(21) Appl. No.: 16/529,037

(22) Filed: Aug. 1, 2019

Related U.S. Application Data
(60) Provisional application No. 62/713,033, filed on Aug. 1, 2018.

(51) Int. Cl. A47J 37/06; A47J 37/07; F24B 1/00

(52) U.S. Cl. CPC A47J 37/0658; A47J 37/0786; F24C 15/20; F24B 1/003; A47J 37/0664

(57) ABSTRACT

A versatile pizza oven comprising a cooking chamber with a cooking surface, an external shell, a heat element operationally installed to provide heat to the cooking chamber, a heat guide plate designed to direct the movement of heat within the cooking chamber, a drip tray at least partially located below the cooking surface, and a channel through which grease and/or crumbs can be moved from the cooking surface and into the drip tray. This cooking apparatus may be provided as a modular kit which can be adapted to pair with an existing griddle or grill, rather than a standalone unit. In this embodiment, the heat source is provided by the griddle or grill.

### CROSS REFERENCE TO RELATED APPLICATIONS

This application claims priority to U.S. Provisional application No. 62/713,033, entitled “Versatile Pizza Oven” which was filed on Aug. 1, 2018.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the versatile pizza oven, which may be embodied in various forms. It is to be understood that in some instances, various aspects of the invention may be shown exaggerated or enlarged to facilitate an understanding of the invention. Therefore the drawings may not be to scale.

FIG. 1 is a front view of the fire chamber assembly with burner.

FIG. 2 is a side by side isometric top view of the pizza oven fire chamber assembly from the left and right side.

FIG. 3 is a cross-section view of the fire chamber from FIG. 1 along the section A-A.

FIG. 4 is an isometric view of the top portion of the fire chamber assembly with the top cover removed.

FIG. 5 is an exploded view of the fire chamber of FIG. 4.

FIG. 6 is an angled view of the bottom half of the fire chamber showing the pizza stone, the lower fire chamber, and the crumb tray/grease trap.

FIG. 7 is an exploded view of the component in FIG. 6.

FIG. 8 is a front view of the bottom portion of the fire chamber assembly.

FIG. 9 is a cross section view of the component in FIG. 8 at section A-A

FIG. 10 is a zoomed in cross section of FIG. 8 at label B to show the chute opening to allow crumbs and grease to move from the cooking surface to the crumb tray/grease trap.

FIG. 11 is a top down view showing the relative locations of the rear burner, heat plate, and grease/crumb chute.

FIG. 12 is an exploded view of another embodiment in which the heat element is not present and the base is designed to be affixed to a griddle or grill top.

FIG. 13 is an angled front view of another embodiment in which the heat element is not present and the base is designed to be affixed to a griddle or grill top showing the shell and door members of the cooking chamber.

FIG. 14 is a rear view of another embodiment in which the heat element is not present and the base is designed to be affixed to a griddle or grill top showing the rear vent hood and the back wall of the cooking chamber.

FIG. 15 is a top down view of another embodiment in which the heat element is not present and the base is designed to be affixed to a griddle or grill top showing the relative locations of the hood and temperature gauge.

FIG. 16 is a horizontal cross section of another embodiment in which the heat element is not present and the base is designed to be affixed to a griddle or grill top showing the fire chamber, cooking chamber and hood.

FIG. 17 is a vertical cross section of another embodiment in which the heat element is not present and the base is designed to be affixed to a griddle or grill top showing the curvilinear heat shield.

### BACKGROUND

Pizza ovens have been around for centuries. The traditional pizza oven is well known in the art. Typically, they are large, cumbersome cooking devices made of refractive materials that are capable of reaching and maintaining high temperatures that can cook pizzas in minutes. Because of their size and cost, pizza ovens are usually found in commercial establishments. However, with the growing trend of residential outdoor kitchens, market demands have recently led to the creation and sale of smaller pizza ovens designed to be a cornerstone of an outdoor kitchen.

The residential pizza oven available today is truly a miniaturized version of centuries old technology; it is not a reimagined cooking tool that meets all of the demands of its target audience. Like its larger cousin, the residential pizza oven is capable of achieving the high temperatures necessary to cook pizza; however, while it does this one task well, that is generally the extent of its utility. It is not capable of providing a gamut of services that consumers expect from their outdoor kitchen appliances.

It is generally known in the industry that the desire to have a great outdoor kitchen faces practical limitations—particularly in terms of space and expense. As population turns more urban, yards are shrinking. Likewise, the expense of an outdoor kitchen is a true luxury, causing enthusiasts to shop around to obtain more “bang” for their “buck.” To balance cost and space, consumers have turned to versatile cooking apparatuses that can provide multiple cooking experiences while taking up a single spot in their outdoor kitchens. For example, the kamado, while also based on centuries old technology, has resurged in popularity due to its versatility. This one cooking apparatus can grill, roast, or smoke, making it a popular item despite its generally high price. Pizza ovens are likewise expensive and take up more room than a kamado; yet, those available on the market today are not nearly as versatile as the kamado. To this day, an easy to use pizza oven apparatus that not only can controllably obtain the high temperatures desired to cook pizza, but also is capable of maintaining low temperatures over a long period of time necessary to smoke meats or bake foods other than pizza, which cannot be cooked at high temperatures does not exists. In alternate embodiments, the concept of the current invention can be made into a modular retrofit kit which can be coupled to an existing cooking device, such as a grill or griddle, to transform it into a more versatile cooking apparatus.

The instant invention seeks to meet the demands of the market by introducing novel concepts and components into a cooking chamber, such as a heat distribution plate inapposite to traditional pizza ovens, a controllable fuel burning heat source, and a grease/crumb chute that will accommodate numerous cooking styles in a single component.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

An exemplary embodiment of a cooking apparatus is provided herein comprising, generally, an insulated fire chamber assembly comprising at least a plurality of contiguous outer walls, an opening, and at least one vent; a cooking chamber defined within the fire chamber with a cooking block upon which food is heated; a heat element capable of controllably heating the cooking chamber; a curvilinear heat shield located above the cooking block that defines the upper portion of the cooking chamber; a temperature control unit; a grease and crumb chute in operational proximity to the cooking block that is separated from the heat element which depends from the cooking chamber and leads to a grease and crumb tray (drip tray) also located at least partially beneath the cooking block; and a temperature gage such as a thermometer. In another embodiment, the heating element is removed entirely and the alternative heat source for the oven comprises an existing griddle or grill onto which the cooking apparatus is affixed, preferably removably thereto.

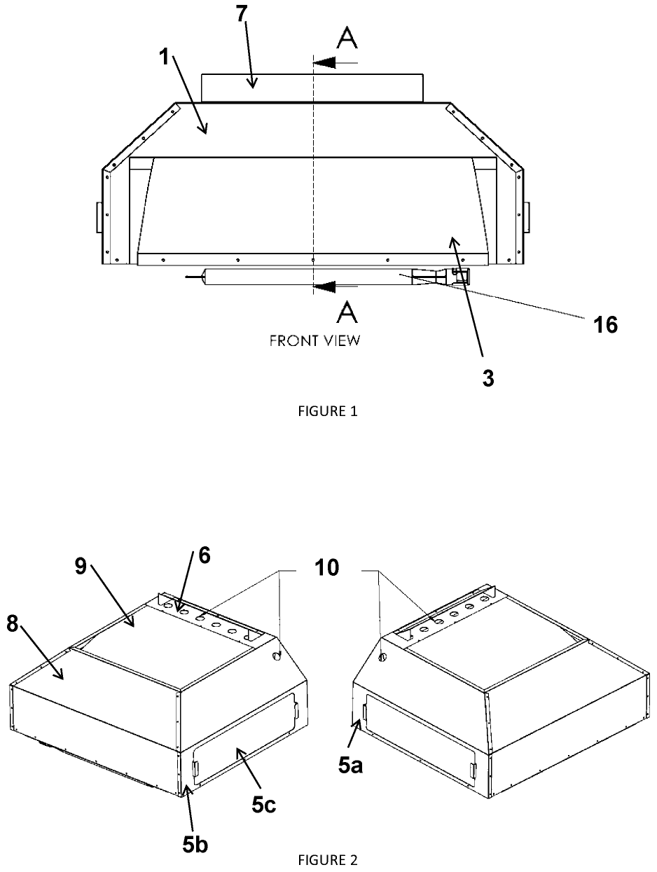

Turning first to FIGS. 1-5, the exterior shell of a pizza oven is shown to be defined by four contiguous walls, including a front wall 1 with access aperture 2 and a door member 3, a rear wall 4 opposite the front wall 1, and two opposing side walls 5a,b that span from front wall 1 to the rear wall 4. The perimeter of the pizza oven is generally closed in by the aforementioned walls as well as a base plate and a hood, with the exception of vent components 10 and access aperture 2 through which food is introduced or removed from the cooking chamber. It is preferred that the walls of the exterior shell are constructed out of thermal insulating materials that are not only capable of withstanding the heat expected to be produced within the pizza oven, but also provide a layer of insulation. As depicted, the walls are constructed of stainless steel, although various other materials may be used such as other metals, ceramics, and alloys. Additionally, one or more walls, or portions thereof, may comprise an at least partially translucent insulated material to allow for viewing into the pizza oven. Suitable materials include thermal glass such as ceramic glass. Adjacent walls are interconnected by one or more connecting means such as molding, welding, and/or mechanical fasteners. When mechanical fasteners are employed, it is preferred that flashings or other thermally treated sealants be used to seal any holes that may be made to minimize heat leakage.

Access aperture 2 is formed in front wall 1 to allow the user to access the contents of the cooking chamber so as to introduce and/or remove food from the chamber as appropriate. As depicted, the aperture is a rectangular shape to allow for multiple types of foods to be introduced, such as pizza which is generally elongated. It is possible that some embodiments would utilize various shaped access apertures such as arch-shaped or rectangular opening. Aperture 2 leads to a landing 2a and heat plate 11 as would be recognized in the art. In most cooking applications and for safety reasons, it may not be desirable to leave the aperture open while using the oven. To solve this issue, one or more door members are operationally installed at the aperture that can be opened or closed. It is preferred that the door members be installed via hinge units about which the door members can be manipulated to move from an open position (wherein the aperture is exposed) to a closed position (wherein the aperture is substantially sealed). In various embodiments, a single door member can be installed that is capable of sealing the aperture. In such an embodiment, the door is generally attached via a horizontal hinge that runs across the bottom of the aperture. As depicted, two swinging door members 3 are used to operationally open and seal the aperture. These door members may be of solid construction or may employ insulated viewing windows.

It is preferred that the door member be able to substantially seal the aperture when in the closed position. To assist in this endeavor, seals may be installed at or near the edge of the door member. Those with skill in the art would recognize that various forms and types of gaskets, rubber seals, or tongue and groove means can be used to provide the desired seal. Additionally, the door members are ideally fitted with handles for ease of manipulation. In a preferred embodiment, the handles are insulated or connected through an insulated barrier such as silicon padding to reduce heat transfer to the handles. In another embodiment, the handles have a grip component that is vacuum sealed to prevent heat transfer to the component.

The base of the exterior shell is generally a substantially flat plate. In various embodiments, the base may be adapted to allow for installation into an outdoor kitchen, a cart, or other external casing such as an insulated sleeve Opposite the base is the top hood of the pizza oven which generally comprises tapered or angled walls extending inwards and upwards from the rear and side walls and a center hood plate that bridges the expanse between these tapered sections. The angled walls assist in directing heat upwards towards the heat vent to allow heat to diffuse out of the oven to ambient.

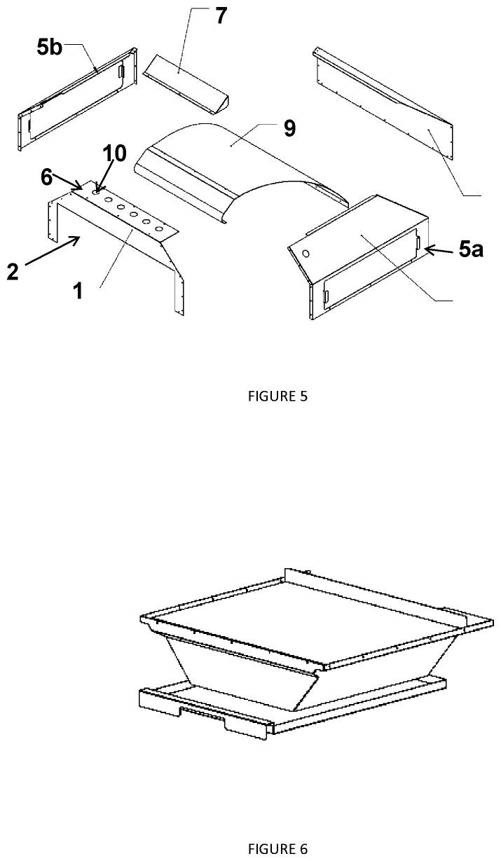

The vent components of the pizza oven can be designed in numerous ways. As depicted, the pizza oven comprises a rear burner 16, and the vents to be located in the front of the unit to force the heat to pass entirely through the cooking chamber before venting to atmosphere. Turning to FIGS. 2 and 5, specifically, front wall 1 spans upwards from the base plate on one end towards the hood on the opposing end. A vent plate with numerous vent apertures extends substantially orthogonally from the front wall towards the rear of the unit. An optional fin 7 is added in this embodiment for safety considerations to direct venting heat away from the front of the unit where a user is most likely to be located. It is also conceivable that additional vents can be bore into the hood and/or side walls. In the particular embodiment, the vents are ideally located near the front due to the positioning of the heat element.

The cooking chamber, the heat element, the heat guide component, and the drip tray are located within the exterior shell. For illustrative purposes only, the discussion of the instant embodiment is broken into two main zones separated by the heat plate 11. The top zone defines the cooking chamber into which food will be inserted for cooking through the pizza oven door as described herein. The heat guide plate is part of the cooking chamber. The lower zone below the heat plate is the fire box and contains the heat element and the drip tray. In another embodiment, the lower zone is modified so that it no longer contains a separate heat element, but is otherwise unchanged. Heat is generated in the fire box by the heat element and moves to the cooking chamber where it contacts and is directed by the heat guide plate. In another embodiment, as explained herein, heat may be generated by an existing grill or griddle and that heat moves into the cooking chamber where it contacts and is directed by the heat guide plate.

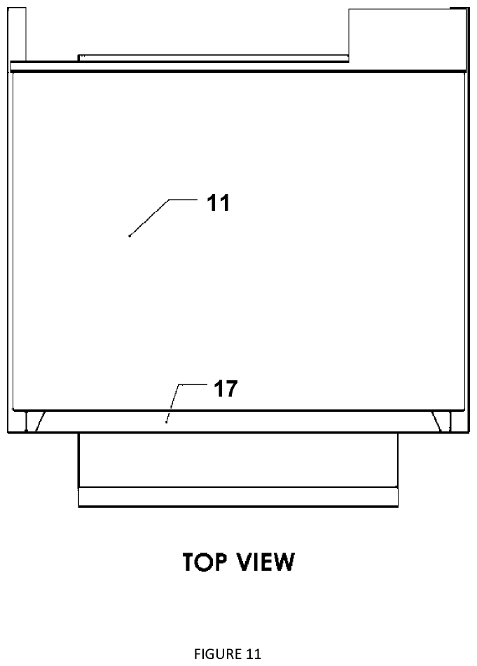

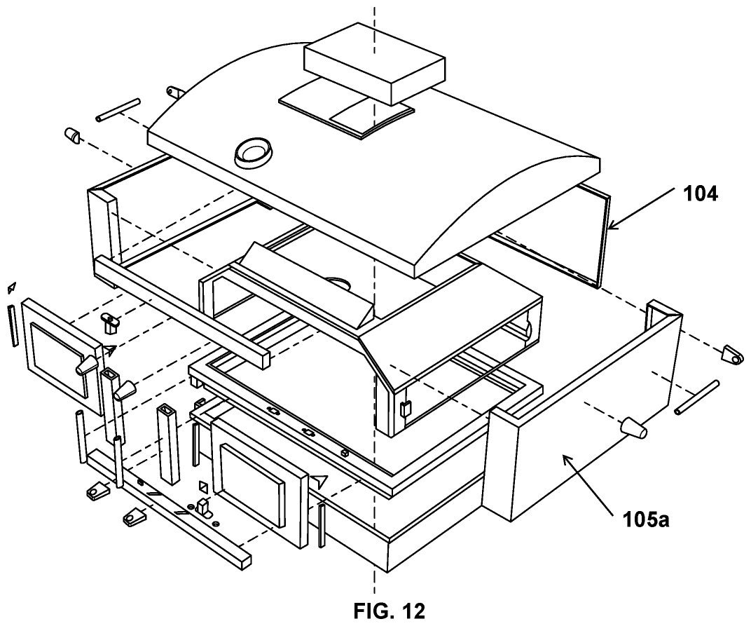

The cooking chamber is the area defined between the top side of the heat plate 11 and the heat guide component 9. The heat plate 11 is a thermal radiating material upon which food is placed for cooking. In a preferred embodiment, the heat plate 11 is a stainless steel plate; however, other materials such as ceramics can be used. The stainless steel plate heats more quickly and evenly than traditional ceramics used as pizza stones. The plate is positioned within the pizza oven unit such that it is accessible through the access aperture 2. As depicted, heat plate 11 rests on brackets or ledges 15 formed in the side walls 5a,b. The heat plate extends substantially from one side wall 5a to the opposing side wall 5b; however, the heat plate 11 does not extend from the interior side of front wall 1 to rear wall 3 in the exemplary embodiment. As depicted best in FIG. 11, gaps are formed between the heat plate 11 and these two walls 1,3 for discrete purposes as described herein.

The firebox is defined below the heat plate 11. FIGS. 6-10 depict a preferred embodiment of the firebox removed from the exterior shell. The depicted fire box is generally defined on the top by the bottom side of the heat plate 11. The firebox is bound on the side by a plurality of angled walls 14a, b, c, d extending downward and inwards from the interior surface of the front, side and rear walls (1, 3, and 5a,b). In the current embodiment, the walls 14 are connected to exterior walls at the same height and location as the brackets or ledges 15. Drip tray 12 is located underneath the bottom edge of the walls 14. It is preferred that the walls 14 terminate close to but do not contact the drip tray 12 so as to not interfere with the removal of the drip tray for cleaning.

Flame or heat element 16 is a gas burner located substantially in the rear of the fire box. In a preferred embodiment, the flame element is controlled by a gas control switch located in the front exterior of the pizza oven. Gas control mechanisms for fuel burners are well known in the industry. It is possible that some embodiments would employ self-adjusting controls to maintain certain temperature ranges. Likewise, it is preferred that the flame or heat element 16 be ignitable by an igniter 16a operationally located adjacent to the burner. In the preferred embodiment, the igniter is also capable of being externally controlled. In a related embodiment, a thermometer, temperature probe, or other temperature indicator is placed within the cooking chamber that is in communication with a display indicator external to the pizza unit so that the user can determine the cooking temperature and adjust the gas control accordingly. In another embodiment, the flame or heat element is removed and the apparatus appropriately modified so that a grill or griddle may be used as the heat source for the apparatus.

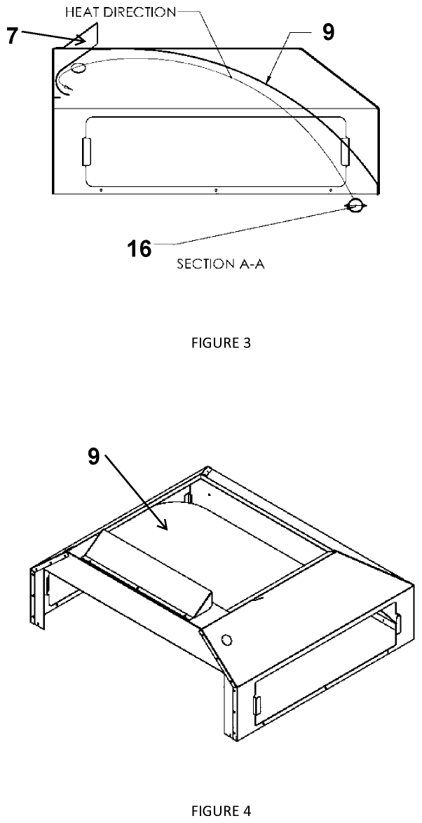

FIGS. 3 and 11 best portray the means by which heat emitted by the flame or heat element 16 enters the cooking chamber. Heat emitted from the heat element rises through the gap between the back side of heat plate 11 and the rear wall 3 and then makes contact with heat guide 9. The heat guide 9 is a curvilinear plate that extends upwards from rear wall 3 in an arch-like manner towards the front wall and hood. Upon reaching the apex of the arch, the heat guide curves back towards the heat plate 11 and culminates in a turn back towards rear wall 3. The angle and degree of the turn may vary in different embodiments. In some embodiments, the degree may be between 45 and 360 degrees. The shape of the heat guide 9 causes the heat from the heat element to circulate upwards around the heat plate (and any food thereon) and back towards the food. The heat emitted from the rear burner 16 effectively rolls along the heat guide until it is guided back towards the heat plate. This circulation allows for more even heat distribution and allows for alternate types of cooking. For example, the directed circulation of heat provided by the curvilinear heat guide in conjunction with a controllable burner allows the unit to maintain set temperatures. In a preferred embodiment, the temperature can be dialed in between 200 degrees and 700 degrees. In smoking applications, the temperature can remain at or between 200-300 degrees. In baking applications, the temperature can remain at or between 300-450 degrees. In broiling applications, the temperature can remain at or between 350-500 degrees. And in searing or flash pizza cooking applications, the temperature can reach well in advance of 500-650 degrees. The gap above the rear burner 16 is also an ideal location to include a wood chip box to provide flavors during a smoke.

The depicted heat guide 9 is a solid plate. To allow heat to ultimately leave the pizza oven, the heat guide 9 does not contact the front wall 1. Instead, another gap is left between the heat guide 9 and front wall 1 to form a flu vent. The heat circulating the system will eventually enter into the flu vent and escape through one or more vent components 10. Upon exiting the vent components 10, the heat will be directed backwards, away from the user by fin 7.

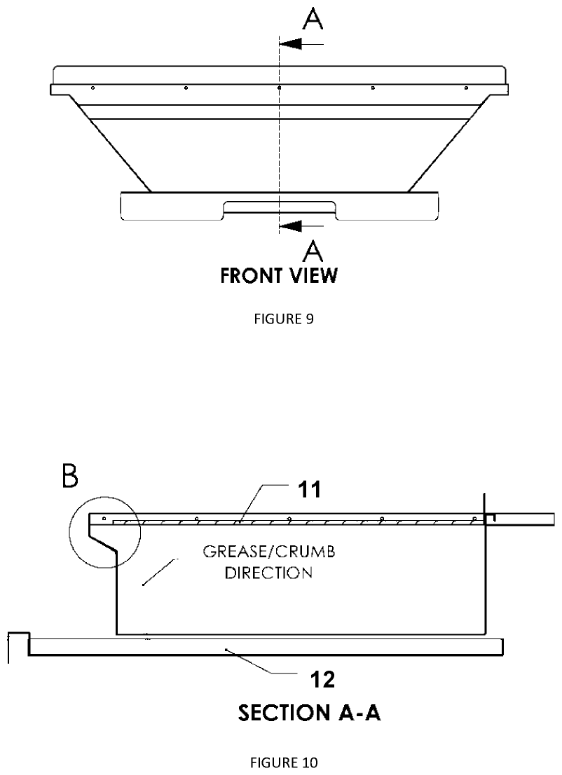

In typical pizza cooking applications, grease is not a problem as the crust of the pizza prevents the grease from contacting the cooking surface or any flame. However, a major goal of the instant invention is to provide a single cooking apparatus that is capable of multiple cooking applications such as grilling or smoking meats and other foods or being used as an oven. Therefore, crumbs and grease need to be taken care of. To accomplish this goal, the system is configured to allow the user to remove the grease and/or crumbs from the cooking chamber. While the gap between the heat plate 11 and rear wall 3 allows heat to enter the cooking chamber, the gap between the front of the heat plate 11 and the front wall 1 (or landing 1a, depending on the embodiment), creates a grease and crumb chute 17. Turning specifically to FIGS. 9 and 10, a grease and crumb chute 17 is depicted as a conduit between the heat plate the fire box front wall 14a. As best shown in FIG. 8, fire box front wall 14a bows outwards at an angle in a semi-funnel shape wherein it contacts exterior front wall 1. The depicted angle is 60 degrees from orientation; however, it is conceivable that the angle can be anywhere between 0-90 degrees depending on the set up. In use, the user can scrape grease and/or crumbs from the heat plate 11 towards the chute 17. Upon reaching the chute, the grease and crumbs will fall into the chute and be trapped in the drip pan.

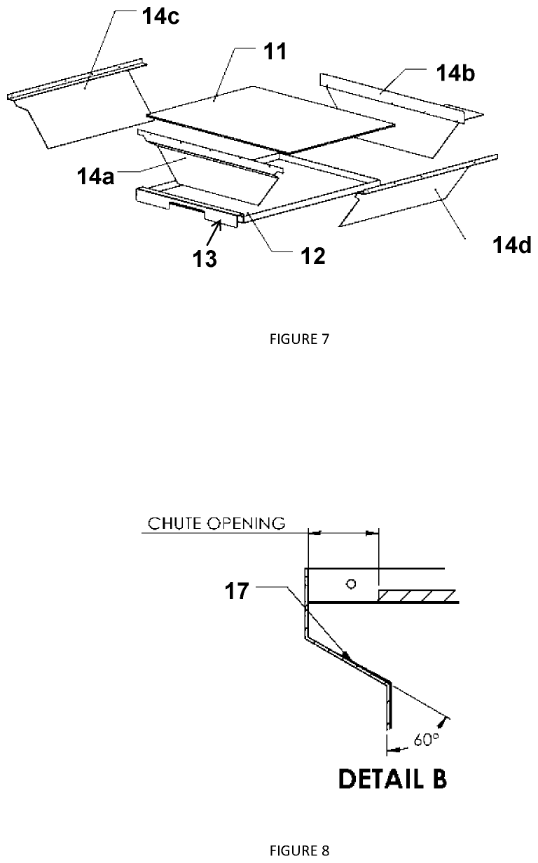

As shown, the drip tray 12 is located at the bottom of the fire box and extends substantially from the front of the firebox to the rear. It is not necessary in all embodiments that the drip pan extends all the way as the crumbs and grease will not flow to the back of the unit. Returning to FIG. 7, the rear inner firebox wall 14b provides a backstop to the heat plate 11, thereby preventing grease and crumbs from falling onto the heat element, causing a flare up or worse. The depicted embodiment spatially separates the drip tray 12 from the bottom of the heat plate. This positioning creates an area of ambient air circulation (further assisted by the circulation caused by the heat guide plate) which reduces temperatures to which the drip tray is exposed, reducing the likelihood of igniting the grease or crumbs located thereon. In the depicted embodiment, the drip tray comprises a handle 13 to aid in removal. The drip tray may be positioned to be accessible from the access aperture 2. However, in the depicted embodiment, the drip tray is accessible through its own slotted opening in front wall 1, and the handle 13 forms a portion of the wall when the drip tray 12 is installed. In another embodiment, the drip tray may be unnecessary if the grill or griddle has an appropriate mechanism for removing crumbs and grease.

A primary purpose of the instant invention is to create a more versatile cooking apparatus in order to ultimately save the user money by reducing the need to purchase multiple equipment pieces. It is understood that many users on the market may already own one or more cooking apparatuses which provide a heat source but do not take advantage of one or more of the novel components conceived in the instant invention. Therefore, in order to better serve the public at large, the instant invention can, in alternate embodiments, be conceived as a modular kit which can be used to retrofit existing cooking apparatuses, such as, for example, a grill or griddle.

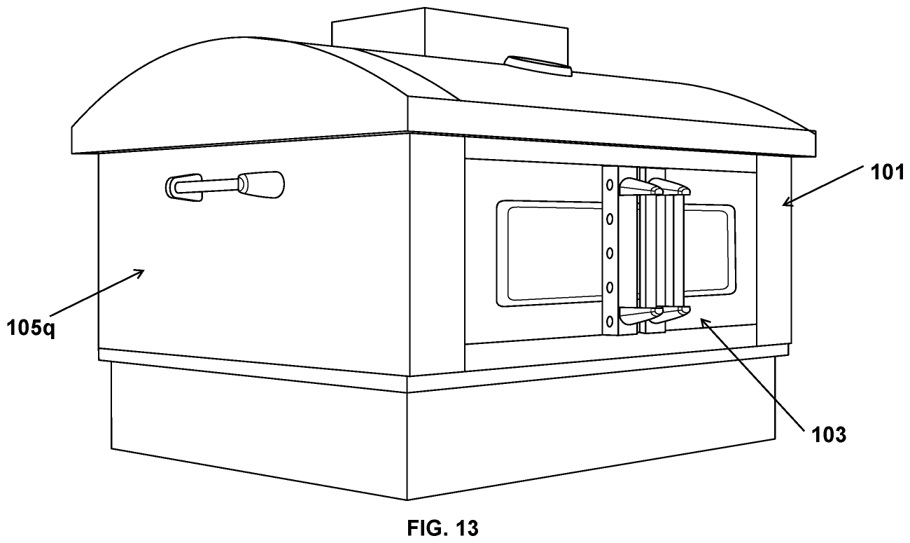

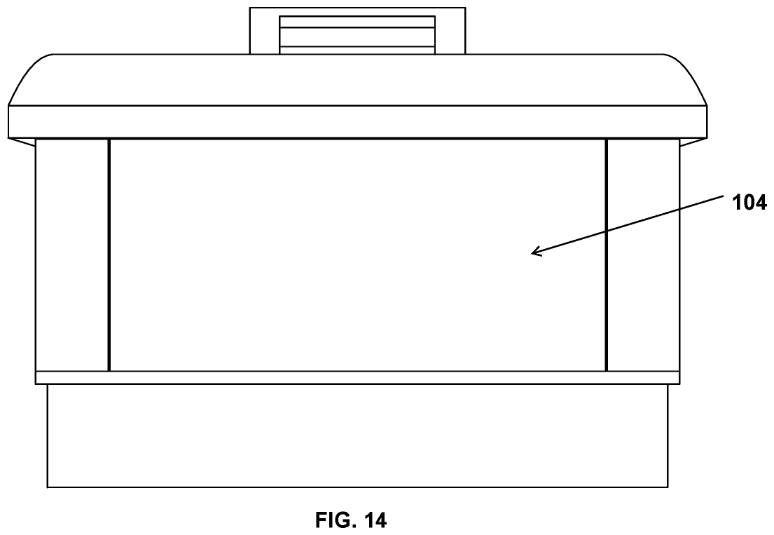

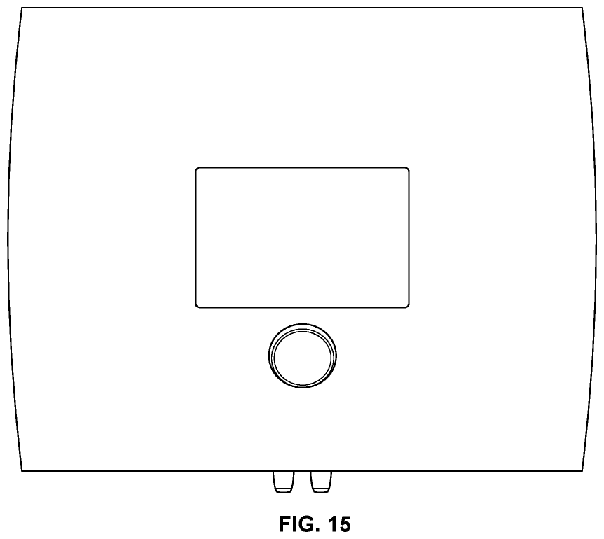

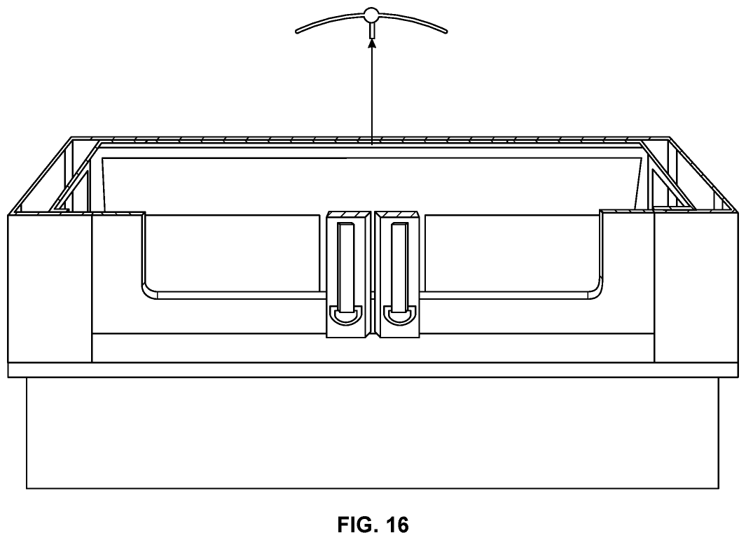

Turning to FIGS. 12-16, a modular embodiment of the present invention is depicted for illustrative purposes to demonstrate that the concept can be adapted to fit an existing grill or griddle. This embodiment comprises a top cooking module which is designed to removably mount on top of an existing cooking device. The module is defined, generally, by a plurality of contiguous side walls and a top wall or hood. As depicted, the module is defined by four contiguous walls, including a front wall 101 with access aperture 102 and a door member 103, a rear wall 104 opposite the front wall 101, and two opposing side walls 105a,b that span from front wall 101 to the rear wall 104. Like the standalone cooking apparatus, the module may comprise one or more door members 103 operationally configured to open or close the aperture 102. In alternate embodiments, either or both the module or the doors may comprise handled to assist with manipulating the components of the unit.

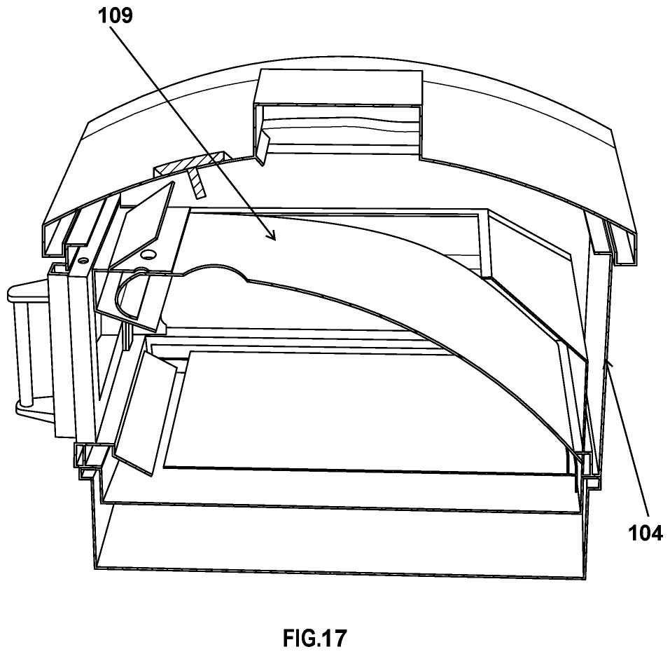

The modular design will also comprise a heat guide. As depicted in FIG. 16, the heat guide 109 is a curvilinear plate that extends upwards from rear wall 103 in an arch-like manner towards the front wall and hood. Upon reaching the apex of the arch, the heat guide curves back towards the heat plate 111 and culminates in a turn back towards rear wall 103. Heat will escape Of course, alternate designs of the heat shield can be utilized. Heat ultimately escapes the modular apparatus through one or more vents and, in the depicted embodiment, is directed away from the front of the apparatus by a vent fin 107.

The module is preferably designed to adapt to and mount, removably, to a pre-existing heat element. To accommodate this design, the module may be between 24-49 inches in width and between 12 and 36 inches in depth. Larger and smaller designs may be conceived.

It may be advantageous in certain embodiments to provide additional support upon which the module can rest. In such an embodiment, the bottoms of the contiguous walls may be widened or otherwise terminate in an orthogonal plate which can provide lateral support. In some embodiments, heat insulating materials may be placed between the module and the external cooking surface, such as an additional metal plate, or a thermal insulating material such as a silicon pad or felt. The thermal insulating materials may be advantageous in producing a substantial seal between the external heat source and the module, but are ideally placed to prevent direct contact between the material and the heat source.

In embodiments wherein a griddle is retrofitted with the module, the heat plate of the external griddle may form the cooking surface when in operation. In an alternate embodiment, the module may have a base in the form of a heat plate which can be placed directly on top of a pre-existing grill grate or griddle. In such an embodiment, the heat plate may form the cooking surface. In alternate embodiments, wherein the module is used on a grill, an external heat plate may be introduced into the environment between the grill grates and the hood of the module so that a cooking surface is introduced.

For the purpose of understanding the inventive pizza oven, references are made in the text to exemplary embodiments of a pizza oven, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change to the basic function to which it is related.

1. A cooking apparatus comprising
a. an external insulated shell comprising a plurality of contiguously attached adjacent walls, wherein each wall is attached to a base plate on one end and a hood on the opposing end, wherein at least one wall comprises an access aperture,
b. a cooking chamber within said shell comprising a cooking surface and a heat guide which itself comprises a curved plate;
c. a heat element operationally positioned to provide heat into the cooking chamber in a manner that the heat will contact the heat guide so that the direction of the heat is manipulated in the cooking chamber by the heat guide.

2. The cooking apparatus of claim 1 further comprising at least one door member operationally attached to the cooking apparatus to open or close at least a portion of the aperture.

3. The cooking apparatus of claim 1 wherein the heat element is a burner located on the side of the apparatus opposite the aperture.

4. The cooking apparatus of claim 3 wherein the hood comprises one or more vents on the side opposite the heat element.

5. The cooking apparatus of claim 1 further comprising a drip tray at least partially underneath the cooking surface and a channel is formed adjacent to the cooking surface that leads to the drip tray.

6. The cooking apparatus of claim 1 wherein at least one side or a door member comprises a semi-transparent material that allows a user to see the cooking surface.

7. The cooking apparatus of claim 5 wherein the drip tray is removable from the unit without need to open the door member.

8. The cooking apparatus of claim 4 wherein a heat deflector is installed adjacent to the vent to direct heat away from the front of the cooking apparatus.

9. A modular conversion kit for versatile cooking comprising
a. an insulated module comprising a plurality of contiguously attached adjacent walls, wherein each wall is attached to a hood on the opposing end, wherein at least one wall comprises an access aperture, said wall defined as the front wall,
b. a heat source located external to and below the module, and;
c. a heat guide located substantially within the module operationally configured to direct heat emanating from the heat source through the cooking chamber.

10. The modular conversion kit of claim 9 further comprising at least one door member operationally attached to the cooking apparatus to open or close at least a portion of the aperture.

11. The modular conversion kit of claim 9 wherein the module comprises a hood further comprising one or more vents configured to direct heat away from the front wall.

12. The modular conversion kit of claim 9 wherein the module comprises a back wall opposite the front wall, and wherein the heat guide comprises a plate which expands outwards and upwards from a position on the back wall into the cooking chamber and towards the front wall.

13. The modular conversion kit of claim 12 wherein the plate is curvilinear, the plate does not contact the front wall, and the plate curves back towards the rear wall on the end opposite the base wall.

14. The modular conversion kit of claim 9 wherein the external heat source is provided from a grill or a griddle.

15. The modular conversion kit for versatile cooking of claim 10 wherein at least one side or a door member comprises a semi-transparent material that allows a user to see the cooking surface.

16. The modular conversion kit for versatile cooking of claim 9 further comprising a drip tray that removable from the unit without need to open the door member.

17. The modular conversion kit for versatile cooking of claim 11 further comprising a heat deflector is installed adjacent to the vent to direct heat away from the front of the cooking apparatus.

18. The modular conversion kit of claim 14 wherein the external heat source is provided by a grill, and wherein the kit further comprises a substantially non-porous cooking surface between the heat source and the heat guide.
